(19) United States
(12) Patent Application Publication
(10) Pub. No.: US 2019/0311464 A1
(43) Pub. Date: Oct. 10, 2019

(54) TUNING FOR DEEP-LEARNING-BASED COLOR ENHANCEMENT SYSTEMS

(71) Applicant: QUALCOMM Incorporated, San Diego, CA (US)

(72) Inventors: Shang-Chih Chuang, San Diego, CA (US); Wei-Chih Liu, Taipei City (TW); Kyuseo Han, San Diego, CA (US); Ying Noyes, San Diego, CA (US); Ho Sang Lee, San Diego, CA (US)

(21) Appl. No.: 15/946,622

(22) Filed: Apr. 5, 2018

(51) Int. Cl. G06T 5/00; G06T 7/90

(52) U.S. Cl. CPC G06T 5/001; G06T 7/90; G06T 2207/10024; G06T 2207/20076; G06T 2207/20092; G06T 2207/20072; G06T 2207/20081

(57) ABSTRACT

A device may obtain a pixel array representing an image and identify one or more representative metrics for the pixel array. The device may retrieve a first version of a mesh defining a color space, wherein the mesh includes a plurality of vertices and each vertex is associated with a respective set of color balance parameters. The device may identify a point in the color space corresponding to the pixel array based on the one or more representative metrics for the pixel array. The device may receive a tuning input comprising a set of color balance parameters for the point and generate a second version of the mesh by adding the point and the set of color balance parameters to the first version of the mesh. The device may output at least one color-corrected image based at least in part on the second version of the mesh.

### BACKGROUND

The following relates generally to color enhancement, and more specifically to tuning for deep-learning-based color enhancement systems.

Spectral responses of human eyes and spectral responses of digital sensors (e.g., cameras) and/or displays may be different. Thus, colors obtained by a digital sensor may differ from colors perceived by humans. For example, the human eye may constantly adjust to a broad range of luminance present in an environment, allowing the brain to interpret information in a wide range of light conditions. Similarly, devices may use image processing techniques to convert image data (e.g., Bayer data) to various color formats and may perform various enhancements and modifications to the raw image. In some cases, these enhancements may include applying one or more color balance gains (e.g., a red gain, a blue gain, a green gain, a combination thereof) to an image (e.g., or a portion of the image). For example, the one or more color balance gains may be applied as part of an auto-white balance (AWB) operation. White balance may change the overall mixture of colors in an image. Without white balance, for example, a display may represent scenes with undesirable tints.

### SUMMARY

The described techniques relate to improved methods, systems, devices, or apparatuses that support tuning for deep-learning-based color enhancement systems. Generally, the described techniques provide for tuning of an auto-white balance (AWB) operation (e.g., based on a user preference or some such input). In accordance with the described techniques, the tuning may in some cases be achieved without having to re-train the entire AWB operation.

A method of color enhancement is described. The method may include obtaining a pixel array representing an image, identifying one or more representative metrics for the pixel array, retrieving, from a system memory of the device, a first version of a mesh defining a color space, wherein the mesh comprises a plurality of vertices and each vertex is associated with a respective set of color balance parameters, identifying a point in the color space corresponding to the pixel array based at least in part on the one or more representative metrics for the pixel array, receiving, from an input controller of the device, a tuning input comprising a set of color balance parameters for the point, generating a second version of the mesh by adding the point and the set of color balance parameters for the point to the first version of the mesh, and outputting at least one color-corrected image based at least in part on the second version of the mesh.

An apparatus for color enhancement is described. The apparatus may include means for obtaining a pixel array representing an image, means for identifying one or more representative metrics for the pixel array, means for retrieving, from a system memory of the device, a first version of a mesh defining a color space, wherein the mesh comprises a plurality of vertices and each vertex is associated with a respective set of color balance parameters, means for identifying a point in the color space corresponding to the pixel array based at least in part on the one or more representative metrics for the pixel array, means for receiving, from an input controller of the device, a tuning input comprising a set of color balance parameters for the point, means for generating a second version of the mesh by adding the point and the set of color balance parameters for the point to the first version of the mesh, and means for outputting at least one color-corrected image based at least in part on the second version of the mesh.

Another apparatus for color enhancement is described. The apparatus may include a processor, memory in electronic communication with the processor, and instructions stored in the memory. The instructions may be operable to cause the processor to obtain a pixel array representing an image, identify one or more representative metrics for the pixel array, retrieve, from a system memory of the device, a first version of a mesh defining a color space, wherein the mesh comprises a plurality of vertices and each vertex is associated with a respective set of color balance parameters, identify a point in the color space corresponding to the pixel array based at least in part on the one or more representative metrics for the pixel array, receive, from an input controller of the device, a tuning input comprising a set of color balance parameters for the point, generate a second version of the mesh by adding the point and the set of color balance parameters for the point to the first version of the mesh, and output at least one color-corrected image based at least in part on the second version of the mesh.

A non-transitory computer-readable medium for color enhancement is described. The non-transitory computer-readable medium may include instructions operable to cause a processor to obtain a pixel array representing an image, identify one or more representative metrics for the pixel array, retrieve, from a system memory of the device, a first version of a mesh defining a color space, wherein the mesh comprises a plurality of vertices and each vertex is associated with a respective set of color balance parameters, identify a point in the color space corresponding to the pixel array based at least in part on the one or more representative metrics for the pixel array, receive, from an input controller of the device, a tuning input comprising a set of color balance parameters for the point, generate a second version of the mesh by adding the point and the set of color balance parameters for the point to the first version of the mesh, and output at least one color-corrected image based at least in part on the second version of the mesh.

In some examples of the method, apparatus, and non-transitory computer-readable medium described above, identifying the one or more representative metrics for the pixel array comprises generating a first representative metric by applying a first set of convolution operations to the pixel array, the first set of convolution operations using a first set of convolution kernels. Some examples of the method, apparatus, and non-transitory computer-readable medium described above may further include processes, features, means, or instructions for generating a second representative metric by applying a second set of convolution operations to the pixel array, the second set of convolution operations using a second set of convolution kernels that may be different from the first set of convolution kernels.

In some examples of the method, apparatus, and non-transitory computer-readable medium described above, identifying the point in the color space for the pixel array includes identifying a horizontal component for the point relative to a coordinate system of the mesh based at least in part on the first representative metric. Some examples of the method, apparatus, and non-transitory computer-readable medium described above may further include processes, features, means, or instructions for identifying a vertical component for the point relative to the coordinate system of the mesh based at least in part on the second representative metric.

In some examples of the method, apparatus, and non-transitory computer-readable medium described above, outputting the at least one color-corrected image based at least in part on the second version of the mesh comprises obtaining a second pixel array representing a second image. Some examples of the method, apparatus, and non-transitory computer-readable medium described above may further include processes, features, means, or instructions for identifying one or more representative metrics for the second pixel array. Some examples of the method, apparatus, and non-transitory computer-readable medium described above may further include processes, features, means, or instructions for accessing the second version of the mesh defining the color space. Some examples of the method, apparatus, and non-transitory computer-readable medium described above may further include processes, features, means, or instructions for identifying a second point in the color space corresponding to the second pixel array based at least in part on the one or more representative metrics for the second pixel array.

Some examples of the method, apparatus, and non-transitory computer-readable medium described above may further include processes, features, means, or instructions for receiving, from the input controller of the device, a second tuning input for the second point, the second tuning input comprising a set of color balance parameters for the second point. Some examples of the method, apparatus, and non-transitory computer-readable medium described above may further include processes, features, means, or instructions for generating a third version of the mesh by adding the second point and the set of color balance parameters for the second point to the second version of the mesh. Some examples of the method, apparatus, and non-transitory computer-readable medium described above may further include processes, features, means, or instructions for outputting the at least one color-corrected image based at least in part on the third version of the mesh.

Some examples of the method, apparatus, and non-transitory computer-readable medium described above may further include processes, features, means, or instructions for performing a color balance operation for the second pixel array based at least in part on the second version of the mesh to generate a color-corrected image. Some examples of the method, apparatus, and non-transitory computer-readable medium described above may further include processes, features, means, or instructions for outputting the color-corrected image.

In some examples of the method, apparatus, and non-transitory computer-readable medium described above, performing the color balance operation for the second pixel array based at least in part on the second version of the mesh comprises identifying a polygon in the second version of the mesh which encompasses the second point, wherein the polygon may be defined by a subset of the plurality of vertices and the point. Some examples of the method, apparatus, and non-transitory computer-readable medium described above may further include processes, features, means, or instructions for determining one or more factors for the color balance operation for the second pixel array based at least in part on the set of color balance parameters associated with the point and the respective set of color balance parameters associated with each of the subset of the plurality of vertices.

In some examples of the method, apparatus, and non-transitory computer-readable medium described above, determining the one or more factors for the color balance operation for the second pixel array comprises determining a respective Euclidean distance in the color space from the second point to each of the subset of the plurality of vertices and to the point. Some examples of the method, apparatus, and non-transitory computer-readable medium described above may further include processes, features, means, or instructions for interpolating between the set of color balance parameters associated with the point and the respective set of color balance parameters associated with each of the subset of the plurality of vertices based at least in part on the determined Euclidean distances to determine the one or more factors for the color balance operation.

In some examples of the method, apparatus, and non-transitory computer-readable medium described above, receiving the tuning input comprises prompting, via a graphical user interface (GUI), a user of the device for the set of color balance parameters for the point.

In some examples of the method, apparatus, and non-transitory computer-readable medium described above, obtaining the pixel array representing the image comprises capturing the image using an image sensor of the device. In some examples of the method, apparatus, and non-transitory computer-readable medium described above, obtaining the pixel array representing the image comprises receiving the pixel array representing the image in a transmission from a second device.

### BRIEF DESCRIPTION OF THE DRAWINGS

FIG. 1 illustrates an example of a pixel array that supports tuning for deep-learning-based color enhancement systems in accordance with aspects of the present disclosure.

FIG. 2 illustrates an example of a convolutional operation that supports tuning for deep-learning-based color enhancement systems in accordance with aspects of the present disclosure.

FIGS. 3A and 3B illustrate example mesh diagrams that support tuning for deep-learning-based color enhancement systems in accordance with aspects of the present disclosure.

FIG. 4 illustrates an example of a process flow that supports tuning for deep-learning-based color enhancement systems in accordance with aspects of the present disclosure.

FIG. 5 shows a block diagram of a device that supports tuning for deep-learning-based color enhancement systems in accordance with aspects of the present disclosure.

FIG. 6 illustrates a block diagram of a system including a device that supports tuning for deep-learning-based color enhancement systems in accordance with aspects of the present disclosure.

FIGS. 7 through 9 illustrate methods for tuning for deep-learning-based color enhancement systems in accordance with aspects of the present disclosure.

### DETAILED DESCRIPTION

An auto white balance (AWB) system may alter a representation of a scene (e.g., a pixel array) such that the representation of the scene matches the perception of human eyes (e.g., so that objects appearing gray for human eyes may be corrected to gray in the representation of the scene). For example, gray objects captured by image sensors may be bluish in high color temperature scenes, reddish in lower color temperature scenes, etc. In practice, an AWB system may detect gray objects in a photo (e.g., objects which may in some cases not have the same red-green-blue (RGB) values) and apply balance gains to the whole image (e.g., or portions thereof) to make these objects appear gray.

In accordance with the described techniques, the AWB system may be an example of or otherwise include a learning-based AWB system (e.g., a machine learning system). That is, a device implementing aspects of the present disclosure may be operable (e.g., may be configured or otherwise controllable by software) to apply various color balance parameters to an image based on some heuristics (e.g., obtained by training the system using other images, input from a user, etc.). In some cases, generation of the AWB system (e.g., based on a training set including a volume of images) may be a computationally intensive process. Aspects of the following may relate to tuning the AWB system (e.g., based on user input, one or more sample images, etc.). For example, the tuning may address so-called “corner case” images, which may negatively impact generation of the AWB system (e.g., during training). Additionally or alternatively, the tuning may allow a user of the system to alter one or more parameters of the AWB system (e.g., without having to retrain the entire system).

Aspects of the disclosure are initially described in the context of a pixel array and related operations. Aspects of the disclosure are then described in the context of a convolutional operation, mesh diagrams, and a process flow. Aspects of the disclosure are further illustrated by and described with reference to apparatus diagrams, system diagrams, and flowcharts that relate to tuning for deep-learning-based color enhancement systems.

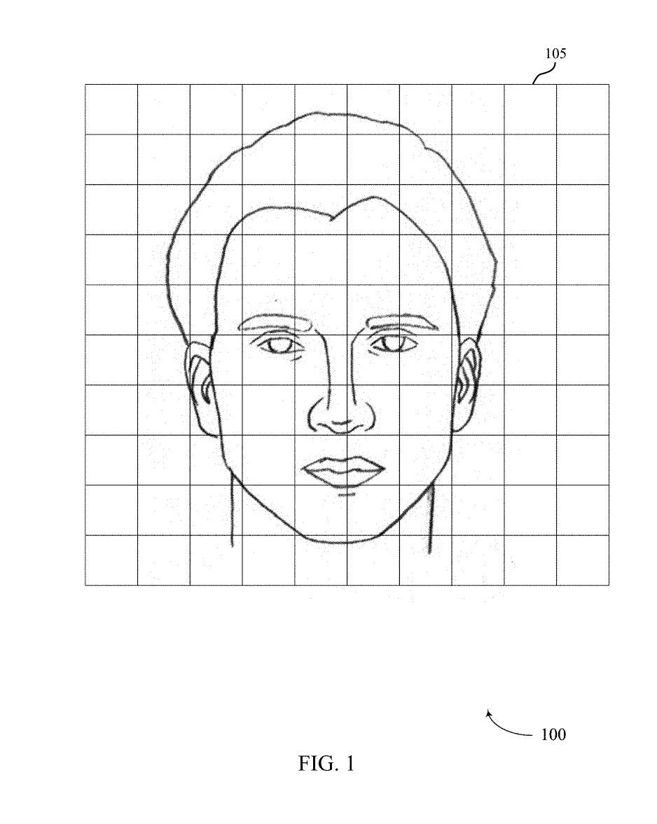

FIG. 1 illustrates an example of a pixel array 100 that supports tuning for deep-learning-based color enhancement systems in accordance with various aspects of the present disclosure. For example, techniques described with reference to pixel array 100 may be performed by a device, such as a mobile device. A mobile device may also be referred to as a user equipment (UE), a wireless device, a remote device, a handheld device, or a subscriber device, or some other suitable terminology, where the “device” may also be referred to as a unit, a station, a terminal, or a client. A mobile device may be a personal electronic device such as a cellular phone, a personal digital assistant (PDA), a tablet computer, a laptop computer, or a personal computer. In some examples, a mobile device may also refer to a wireless local loop (WLL) station, an Internet of Things (IoT) device, an Internet of Everything (IoE) device, a machine type communication (MTC) device, or the like, which may be implemented in various articles such as appliances, vehicles, meters, or some other suitable terminology.

A device performing the techniques described with reference to pixel array 100 may include or be an example of a camera sensor that captures information. The captured information may comprise an output of the camera sensor that could be used to define one or more still image photographs, or image frames of a video sequence. Pixel array 100 may represent an example of such an output.

In accordance with the described techniques, the device may in some cases apply one or more processing operations to pixel array 100. For example, the device may apply an AWB operation. In some cases, the device may include an image signal processor (ISP), which is operable to apply the processing operations to pixel array 100 (e.g., to generate a color-corrected image for display by another component of the device). By way of example, the device may process image array 100 to identify a suitable color balance operation (e.g., in accordance with aspects of the present disclosure). The color balance operation may adjust the RGB values (e.g., or other color component values) of the pixels 105 which comprise pixel array 100 to generate a color-corrected image. In some cases, the color balance operation may be applied to all pixels 105 in pixel array 100. Alternatively, the color balance operation may be applied to a subset of pixels 105 in pixel array. The device may then output the color-corrected image. In aspects of the present disclosure, outputting the color-corrected image may include one or more of displaying the color-corrected image (e.g., to a user of the device), transmitting the color-corrected image to another device (e.g., via a wireless link), storing the color-corrected image in a memory of the device, or the like.

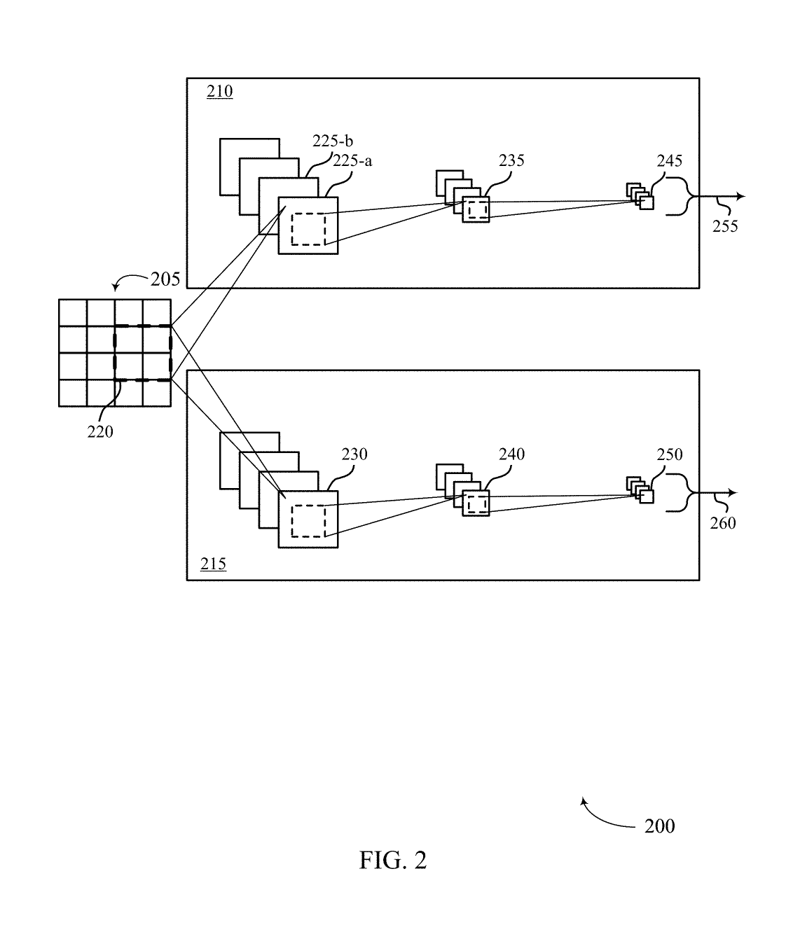

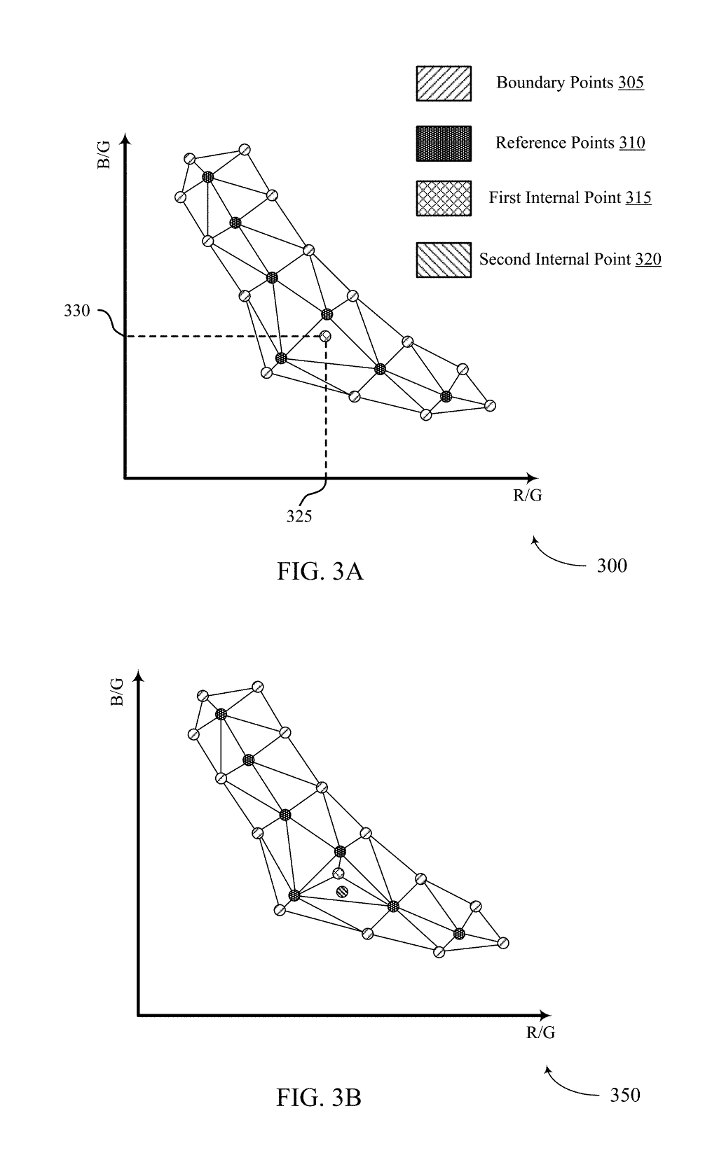

FIG. 2 illustrates an example of a convolutional operation 200 that supports tuning for deep-learning-based color enhancement systems in accordance with various aspects of the present disclosure. For example, convolutional operation 200 may in some cases be performed by a device performing the processing operations described with reference to pixel array 100. Additionally or alternatively, convolutional operation 200 may be performed by another device (e.g., a server, a remote device, or the like), and the output of convolutional operation 200 may be communicated to the device (e.g., via a wireless link, via a non-transitory computer readable medium, or the like). For example, convolutional operation 200 may be used to process an image (e.g., pixel array 100) to generate one or more input parameters, which input parameters may be used in conjunction with the mesh diagrams described with reference to FIGS. 3A and 3B to achieve AWB (e.g., or some other image processing) for the image.

By way of example, convolutional operation 200 may relate to a pixel array 205 (e.g., which may be an example of pixel array 100). Pixel array 200 may in some cases represent an image used to train an AWB system (e.g., an image from a training set). Alternatively pixel array 200 may represent an image captured by an image sensor of the device. Although illustrated as containing sixteen pixels for the sake of illustration, it is to be understood that pixel array 205 may include any suitable number of pixels.

Convolutional operation 200 may include a first set of feature map operations 210 and a second set of feature map operations 215. In some cases, the first set of feature map operations 210 and the second set of feature map operations 215 may comprise analogous feature map operations (e.g., the same mathematical operations may be applied in each set, with possibly different parameters used for each respective set).

For example, the first set of feature map operations 210 may include generation of a first set of feature maps 225. By way of example, feature map 225-a may be generated by iteratively applying a first kernel to pixel array 205, where iteratively applying the first kernel comprises stepping (e.g., striding) the first kernel across pixel array 205. For example, the first kernel may apply a first set of weights to each pixel in region 220 to generate a first feature element for feature map 225-a. The first kernel may then apply the first set of weights to each pixel in another region of pixel array 205 (e.g., where the other region is related to region 220 by some stride size). Similarly, feature map 225-b may be generated by iteratively applying a second kernel to pixel array 205 (e.g., where the second kernel may apply a second set of weights to each region of pixel array 205). Likewise, feature map 230 may be generated by iteratively applying a third kernel to pixel array 205 (e.g., where the third kernel may apply a third set of weights to each region of pixel array 205).

As illustrated, convolutional operation 200 may in some cases include multiple layers, where each layer is associated with a respective set of feature maps. Thus, feature map 235 may be generated by applying a fourth kernel to feature map 225-a (e.g., where the fourth kernel may apply a fourth set of weights to each region of feature map 225-a). As discussed with reference to pixel array 205, the regions of feature map 225-a to which the fourth kernel is applied may be based on a stride size (e.g., which may be different from the stride size used for pixel array 205). Similarly, feature map 240 may be generated by applying a fifth kernel to feature map 230 (e.g., where the fifth kernel may apply a fifth set of weights to each region of feature map 230).

Analogous techniques may be used to generate feature map 245 from feature map 235 (e.g., and to generate feature map 250 from feature map 240). Though illustrated with three layers, it is to be understood that convolutional operation 200 may include any suitable number of layers. Additionally, in some cases, the first set of feature map operations 210 and the second set of feature map operations 215 may include different numbers of layers (e.g., or include a different number of feature maps for each layer or be otherwise distinct from each other).

In some cases, the last layers of the first set of feature map operations 210 and the second set of feature map operations 215 (e.g., the layer containing feature map 245 and feature map 250) may be referred to as fully-connected layers. In accordance with the described techniques, convolutional operation 200 may produce a first output 255 (from the first set of feature map operations 210) and a second output 260 (from the second set of feature map operations 215). For example, the first output 255 may be an example of a red gain (R gain) for pixel array 205 while the second output 260 may be an example of a blue gain (B gain) for pixel array 205.

In cases in which convolutional operation 200 is used for training, multiple images may be processed using convolutional operation 200 (e.g., hundreds of images, thousands of images, etc.). Accordingly, such training may be computationally complex. Further, some images may behave poorly during convolutional operation 200 (e.g., may result in respective first output 255 and second output 260 which are not accurate representations of the image). Such images may negatively impact the efficacy of the training or may otherwise be difficult to handle. Aspects of the present disclosure may relate to techniques for processing such images. That is, aspects of the present disclosure may relate to tuning an AWB system by adjusting aspects of convolutional operation 200 (e.g., where the tuning may be based on some input from a user).

Example adjustments to convolutional operation 200 include different weights for one or more of the kernels discussed above, different stride lengths, different numbers of layers, different numbers of feature maps for each layer, different weighting for the fully connected layer, and the like. For example, the AWB system may be trained with a large number of input images (e.g., with user-labeled preferences). The AWB system may be trained to achieve a threshold loss for the training set (e.g., using various adjustments described above). Depending on the image set size and the target loss threshold, such training may require large amounts of time and/or processing power. Aspects of the present disclosure relate to updating an AWB system (e.g., based on a first output 255 and a second output 260 for a pixel array 205) without having to retrain the entire network.

FIGS. 3A and 3B illustrate example mesh diagrams 300 and 350, respectively, that support tuning for deep-learning-based color enhancement systems in accordance with various aspects of the present disclosure. Mesh diagram 300 and mesh diagram 350 may be defined in a red/green (R/G) and blue/green (B/G) color domain. Mesh diagram 300 and mesh diagram 350 may comprise a plurality of boundary points 305 and a second plurality of reference points 310. As discussed below, the boundary points 305 may in some cases be defined according to (e.g., with reference to) the reference points 310.

Reference points 310 may be calibrated under respective standard illuminants (e.g., D75, D65, D50, TL84, CW, A, and H). Boundary points 305 may be defined according to reference points 310 and boundary distances. For example, each of reference points 310 may be associated with two or more boundary points 305. Each reference point 310 and boundary point 305 may be associated with pre-defined values for one or more white balance parameters. For instance, each reference point 310 and boundary point 305 may be associated with a pre-defined aggregation weight (AW), a pre-defined color correction matrix (CCM), and a pre-defined color temperature (CT).

In some examples, mesh diagram 300 may include or be based on a black body locus curve by a n^{th}-order polynomial fit for reference points 310. In some examples, mesh diagram 300 may be based on automatic boundary point 305 generation. For instance, to determine a pair of boundary points 305 for a given reference point 310, a device may compute a tangent line lₜ of the n^{th}-order polynomial equation at the given reference point 310 and generate the two corresponding boundary points 305 that are located on a perpendicular line lₚ to the computed tangent line.

In computational geometry, triangulation (e.g., Delaunay triangulation) is a technique to divide a space into multiple triangles. In accordance with one or more techniques of the present disclosure, a device may obtain mesh diagram 300, which is defined by a plurality of polygons. In some examples, the plurality of polygons may have vertices at reference points 310 and/or at boundary points 305. For instance, the device may perform triangulation to obtain a triangular mesh defining a plurality of triangles having vertices at reference points 310 and/or boundary points 305.

In some cases, a first internal point 315 may be identified (e.g., based on an output of convolutional operation 200 for a given pixel array). For example, first internal point 315 may be defined within the coordinate system of mesh diagram 300 based on a horizontal component 325 (e.g., which may be or be based on first output 255) and a vertical component 330 (e.g., which may be or be based on second output 260). Thus, aspects of the following relate to determining a representative point for an image (e.g., or a portion thereof such as a single pixel or a set of pixels) within mesh diagram 300, where the coordinates of the representative point may be based on one or more outputs of convolutional operation 200.

In accordance with one or more techniques of this disclosure, a device may utilize point location by straight walking to identify a triangle of a mesh diagram 300 that includes a first internal point 315. To perform point location by straight walking, the device may evaluate whether a particular point is within a first triangle of a plurality of triangles. If the particular point is not within the first triangle, the device may select a next triangle of the plurality of triangles to evaluate based on which edge of the first triangle is crossed by a line between the particular point and a Barycentric point of the first triangle. For instance, the device may select the next triangle to evaluate as the neighboring triangle of the first triangle that shares the edge of the first triangle is crossed by a line between the particular point and the Barycentric point of the first triangle. The device may repeat this process until identifying a triangle of the plurality of triangles that includes the particular point.

In some cases, a device implementing aspects of the present disclosure may identify a triangle of mesh diagram 300 which contains first internal point 315 and determine one or more white balance parameters for first internal point 315 based on an interpolation of white balance parameters associated with vertices of the identified triangle. For example, the device may perform a Barycentric interpolation to determine the one or more white balance parameters. To perform the Barycentric interpolation, the device may determine the area of the sub-triangles generated by connecting first internal point 315 to each of the reference points 310 defining the identified triangle. For example, the device may compute:

$$areaA = \vert \frac{{P}_{x} ( {B}_{y} - {C}_{y} ) + {B}_{x} ( {C}_{y} - {P}_{y} ) + {C}_{x} ( {P}_{y} - {B}_{y} )}{2} \vert , \\ areaB = \vert \frac{{A}_{x} ( {P}_{y} - {C}_{y} ) + {P}_{x} ( {C}_{y} - {A}_{y} ) + {C}_{x} ( {A}_{y} - {P}_{y} )}{2} \vert , and \\ areaC = \vert \frac{{A}_{x} ( {B}_{y} - {P}_{y} ) + {B}_{x} ( {P}_{y} - {A}_{y} ) + {P}_{x} ( {A}_{y} - {B}_{y} )}{2} \vert \qquad ( 1 )$$

where Aₓ, A_{y} are the x-y coordinates of a first reference point 310, Bₓ, B_{y} are the x-y coordinates of a second reference point 310, Cₓ, C_{y} are the x-y coordinates of point a third reference point 310, and Pₓ, P_{y} are the x-y coordinates of first internal point 315.

The device may determine a value for a white balance parameter of first internal point 315 based on the determined areas and values of the white balance parameter for the reference points 310. For instance, the device may determine:

$${P}_{value} = \frac{{A}_{value} \times areaA + {B}_{value} \times areaB + {C}_{value} \times areaC}{areaA + areaB + areaC} \qquad ( 2 )$$

where Pᵥₐₗᵤₑ is the value for the white balance parameter determined for first internal point 315, Aᵥₐₗᵤₑ is a pre-determined value for the white balance parameter for the first reference point 310 defining the identified triangle, Bᵥₐₗᵤₑ is a pre-determined value for the white balance parameter for the second reference point 310 defining the identified triangle, and Cᵥₐₗᵤₑ is a pre-determined value for the white balance parameter for the third reference point 310 defining the identified triangle.

The device may determine a final balance gain pair for the image based on Pᵥₐₗᵤₑ. For instance, the device may determine the final balance gain pair (GainF_{R}′, GainF_{G}′, GainF_{B}′) in accordance with Equations (3), below, where Gain_{R} is the red component of the balance gain pair (e.g., first output 255 as described with reference to FIG. 2), Gain_{B} is the blue component of the balance gain pair (e.g., second output 260 as described with reference to FIG. 2), AG_{R} is the red component of the adjust gain pair (e.g., the red component of Pᵥₐₗᵤₑ as determined in accordance with Equation (2 )), and AG_{b} is the blue component of the adjust gain pair (e.g., the blue component of Pᵥₐₗᵤₑ as determined in accordance with Equation (2)).

$$\begin{matrix}{GainF}_{R} = {Gain}_{R} \times {AG}_{R} , \\ {GainF}_{B} = {Gain}_{B} \times {AG}_{B} , \\ {GainF}_{R}^{′} = \frac{{GainF}_{R}}{min ( {GainF}_{R} , {GainF}_{B} , 1.0 )} , \\ {GainF}_{B}^{′} = \frac{{GainF}_{B}}{min ( {GainF}_{R} , {GainF}_{B} , 1.0 )} , and \\ {GainF}_{G}^{′} = \frac{1.0}{min ( {GainF}_{R} , {GainF}_{B} , 1.0 )}\end{matrix} \qquad ( 3 )$$

The device may perform, based on the final balance gain pair, a white balance operation on the image data. For instance, the device may modify the RGB values of pixels of image data based on the determined final balance gain pair.

Additionally, in accordance with one or more techniques of this disclosure, the device may enable the insertion of additional points such as first internal point 315 into mesh diagram 300 (i.e., to facilitate control of non-uniform distribution of AWB outputs in a given color space). For instance, such an insertion may be used to generate mesh diagram 350 as illustrated with reference to FIG. 3B. First internal point 315 may be associated with values for white balance parameters. For example, the first internal point 315 may be associated with a CCM, CT, and AG. Once the new point is added, a new triangulation process may be performed. For instance, as shown in FIG. 3B, a triangulation process resulting from the addition of first internal point 315 may result in a triangle of mesh diagram 300 being divided into three separate triangles, each having a vertex at first internal point 315.

Adding a point into the mesh could directly and intuitively control its CCM, CT, and AG (e.g., making it easier to tune a specific scene). Tuning a specific scene may not lead to large-scale AWB changes for the system. In some examples, multiple such points maybe added to the mesh. As more points are added to mesh diagram 350, AWB may become more accurate. Thus, generation of AWB parameters for second internal point 320 based on mesh diagram 350 may be more accurate than a corresponding generation of AWB parameters for second internal point 320 based on mesh diagram 300. In some cases, second internal point 320 may be located within the coordinate system of mesh diagram 350 based on one or more outputs of convolutional operation 200 (e.g., as described for first internal point 315 with respect to horizontal component 325 and vertical component 330).

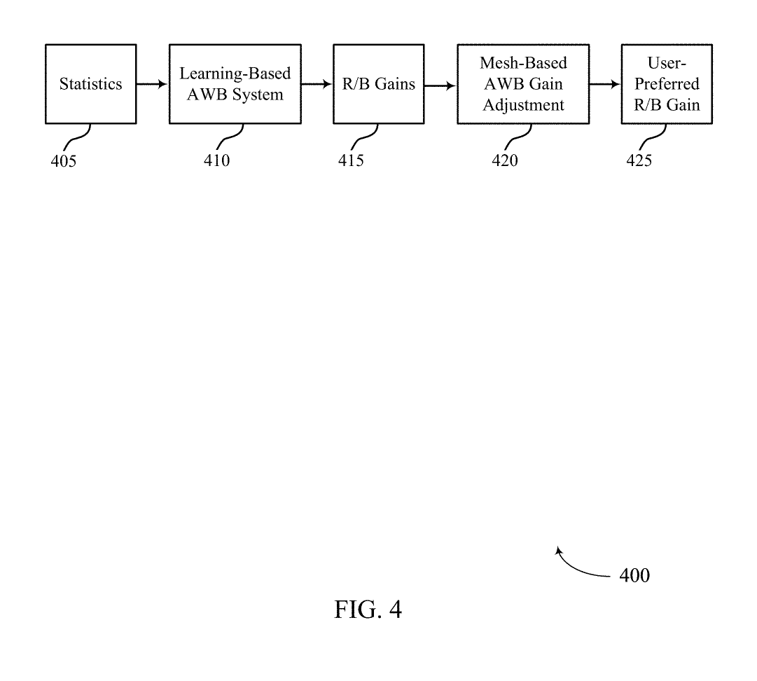

FIG. 4 illustrates an example of a process flow 400 that supports tuning for deep-learning-based color enhancement systems in accordance with various aspects of the present disclosure. For example, process flow 400 may be implemented by a device (e.g., as described with reference to FIG. 1). In some cases, process flow 400 may be performed by multiple devices (e.g., where each device may perform one or more portions of process flow 400).

At 405, a device may determine one or more statistics for an image. For example, the statistics may be represented by a pixel array such as pixel array 205 described with reference to FIG. 2. That is, in some cases, the statistics may include one or more color component values for a pixel in an image (e.g., or a group of pixels in the image). Examples of such statistics include Bayer data, luminance information, saturation information, color temperature, etc.

At 410, the device may implement a learning-based AWB system (e.g., using techniques described with reference to convolutional operation 200).

At 415, the device may determine a R gain and B gain based on the learning-based AWB system (e.g., using techniques described with reference to convolutional operation 200).

At 420, the device may implement a mesh-based AWB gain adjustment (e.g., as described with reference to mesh diagram 300 and/or mesh diagram 350).

At 425, the device may output a color-corrected image based on the mesh-based AWB gain adjustment. For example, the color-corrected image may be based on a user-preferred adjustment.

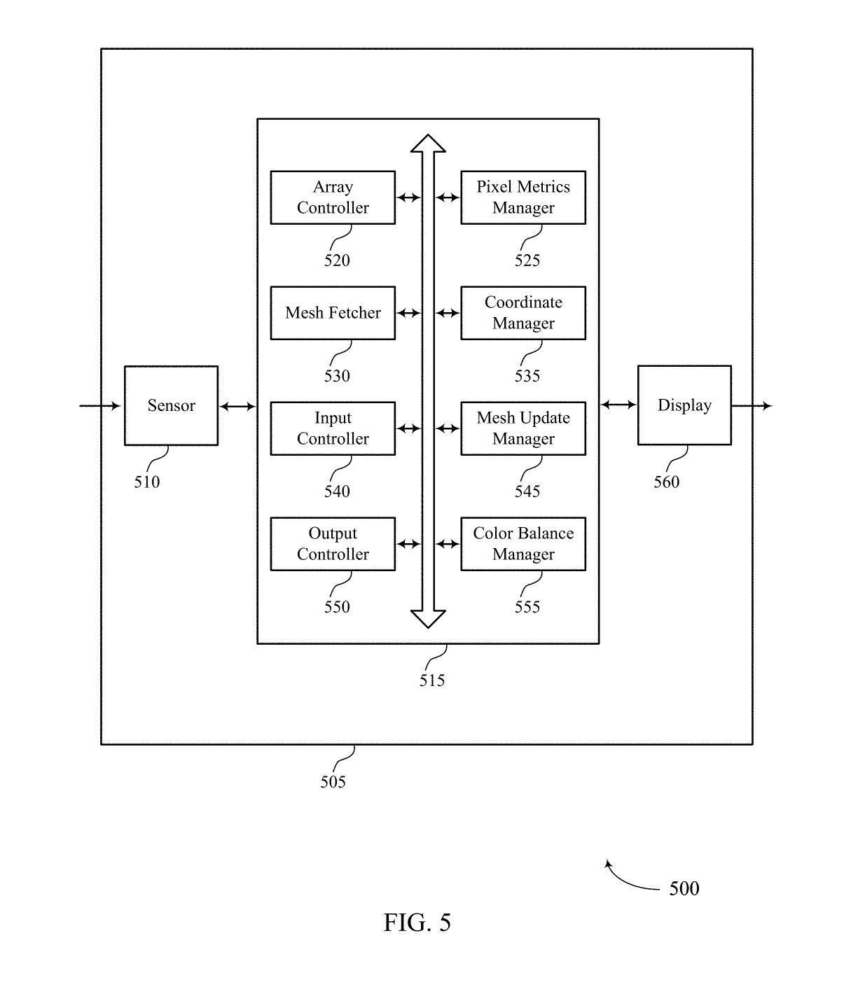

FIG. 5 shows a block diagram 500 of a device 505 that supports tuning for deep-learning-based color enhancement systems in accordance with aspects of the present disclosure. Device 505 may include sensor 510, image processing controller 515, and display 560. Device 505 may also include a processor. Each of these components may be in communication with one another (e.g., via one or more buses).

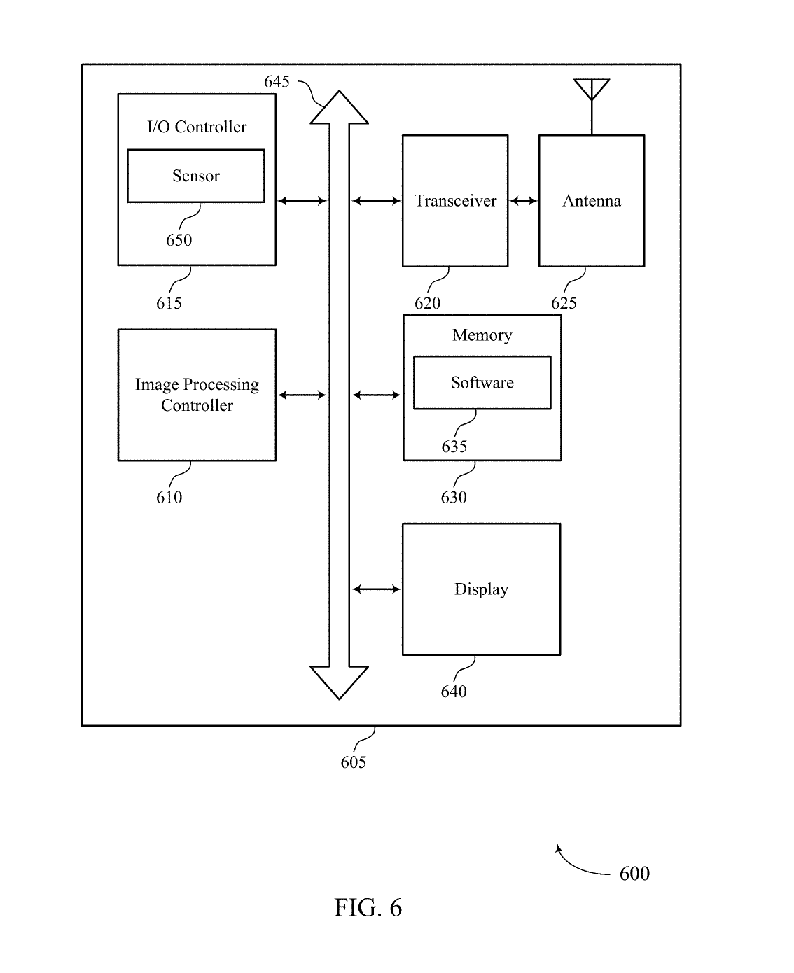

Sensor 510 may include or be an example of a digital imaging sensor for taking photos and video. In some examples, sensor 510 may receive information such as packets, user data, or control information associated with various information channels (e.g., from a transceiver 620 described with reference to FIG. 6). Information may be passed on to other components of the device. Additionally or alternatively, components of device 505 used to communicate data over a wireless (e.g., or wired) link may be in communication with image processing controller 515 (e.g., via one or more buses) without passing information through sensor 510.

Image processing controller 515 may be an example of aspects of the image processing controller 615 described with reference to FIG. 6. Image processing controller 515 and/or at least some of its various sub-components may be implemented in hardware, software executed by a processor, firmware, or any combination thereof. If implemented in software executed by a processor, the functions of the image processing controller 515 and/or at least some of its various sub-components may be executed by a general-purpose processor, a digital signal processor (DSP), an application-specific integrated circuit (ASIC), an field-programmable gate array (FPGA) or other programmable logic device, discrete gate or transistor logic, discrete hardware components, or any combination thereof designed to perform the functions described in the present disclosure.

The image processing controller 515 and/or at least some of its various sub-components may be physically located at various positions, including being distributed such that portions of functions are implemented at different physical locations by one or more physical devices. In some examples, image processing controller 515 and/or at least some of its various sub-components may be a separate and distinct component in accordance with various aspects of the present disclosure. In other examples, image processing controller 515 and/or at least some of its various sub-components may be combined with one or more other hardware components, including but not limited to an I/O component, a transceiver, a network server, another computing device, one or more other components described in the present disclosure, or a combination thereof in accordance with various aspects of the present disclosure.

The image processing controller 515 may include array controller 520, pixel metrics manager 525, mesh fetcher 530, coordinate manager 535, input controller 540, mesh update manager 545, output controller 550, and color balance manager 555. Each of these modules may communicate, directly or indirectly, with one another (e.g., via one or more buses).

Array controller 520 may obtain a pixel array representing an image. Array controller 520 may obtain a second pixel array representing a second image. In some cases, obtaining the pixel array representing the image includes capturing the image using an image sensor of the device. Additionally or alternatively, obtaining the pixel array may include receiving the pixel array representing the image in a transmission from a second device

Pixel metrics manager 525 may identify one or more representative metrics for the pixel array. Pixel metrics manager 525 may generate a first representative metric by applying a first set of convolution operations to the pixel array, the first set of convolution operations using a first set of convolution kernels. Pixel metrics manager 525 may generate a second representative metric by applying a second set of convolution operations to the pixel array, the second set of convolution operations using a second set of convolution kernels that is different from the first set of convolution kernels. Pixel metrics manager 525 may identify one or more representative metrics for the second pixel array.

Mesh fetcher 530 may retrieve, from a system memory of device 505, a first version of a mesh defining a color space, where the mesh includes a set of vertices and each vertex is associated with a respective set of color balance parameters. Similarly, mesh fetcher 530 may access the second version of the mesh defining the color space.

Coordinate manager 535 may identify a point in the color space corresponding to the pixel array based on the one or more representative metrics for the pixel array. Similarly, coordinate manager 535 may identify a second point in the color space corresponding to the second pixel array based on the one or more representative metrics for the second pixel array. For example, coordinate manager 535 may identify a horizontal component for the point relative to a coordinate system of the mesh based on the first representative metric and a vertical component for the point relative to the coordinate system of the mesh based on the second representative metric.

Input controller 540 may receive a tuning input including a set of color balance parameters for the point. Input controller 540 may receive a second tuning input for the second point, the second tuning input including a set of color balance parameters for the second point. In some cases, receiving the tuning input includes prompting, via a graphical user interface (GUI), a user of device 505 for the set of color balance parameters for the point.

Mesh update manager 545 may generate a second version of the mesh by adding the point and the set of color balance parameters for the point to the first version of the mesh. Similarly, mesh update manager 545 may generate a third version of the mesh by adding the second point and the set of color balance parameters for the second point to the second version of the mesh.

Output controller 550 may output at least one color-corrected image based on the second version of the mesh, the third version of the mesh, or some combination thereof.

Color balance manager 555 may perform a color balance operation for the second pixel array based on the second version of the mesh to generate a color-corrected image. Color balance manager 555 may identify a polygon in the second version of the mesh which encompasses the second point, where the polygon is defined by a subset of the set of vertices and the point. Color balance manager 555 may determine a respective Euclidean distance in the color space from the second point to each of the subset of the set of vertices and to the point. Color balance manager 555 may determine one or more factors for the color balance operation for the second pixel array based on the set of color balance parameters associated with the point and the respective set of color balance parameters associated with each of the subset of the set of vertices. Color balance manager 555 may interpolate between the set of color balance parameters associated with the point and the respective set of color balance parameters associated with each of the subset of the set of vertices based on the determined Euclidean distances to determine the one or more factors for the color balance operation.

Display 560 may be a touchscreen, a light emitting diode (LED), a monitor, etc. In some cases, display 560 may be replaced by system memory. That is, in some cases in addition to (or instead of) being displayed by device 505, the processed image may be stored in a memory of device 505.

FIG. 6 shows a diagram of a system 600 including a device 605 that supports tuning for deep-learning-based color enhancement systems in accordance with aspects of the present disclosure. Device 605 may be an example of or include the components of device 505. Device 605 may include components for bi-directional voice and data communications including components for transmitting and receiving communications. Device 605 may include image processing controller 610, I/O controller 615, transceiver 620, antenna 625, memory 630, software 635, and display 640. These components may be in electronic communication via one or more buses (e.g., bus 645).

Image processing controller 610 may include an intelligent hardware device, (e.g., a general-purpose processor, a digital signal processor (DSP), an image signal processor (ISP), a central processing unit (CPU), a graphics processing unit (GPU), a microcontroller, an application-specific integrated circuit (ASIC), a field-programmable gate array (FPGA), a programmable logic device, a discrete gate or transistor logic component, a discrete hardware component, or any combination thereof). In some cases, image processing controller 610 may be configured to operate a memory array using a memory controller. In other cases, a memory controller may be integrated into image processing controller 610. Image processing controller 610 may be configured to execute computer-readable instructions stored in a memory to perform various functions (e.g., functions or tasks supporting face tone color enhancement).

I/O controller 615 may manage input and output signals for device 605. I/O controller 615 may also manage peripherals not integrated into device 605. In some cases, I/O controller 615 may represent a physical connection or port to an external peripheral. In some cases, I/O controller 915 may utilize an operating system such as iOS®, ANDROID®, MS-DOS®, MS-WINDOWS®, OS/2®, UNIX®, LINUX®, or another known operating system. In other cases, I/O controller 615 may represent or interact with a modem, a keyboard, a mouse, a touchscreen, or a similar device. In some cases, I/O controller 615 may be implemented as part of a processor. In some cases, a user may interact with device 605 via an I/O controller 615 or via hardware components controlled by I/O controller 615. In some cases, I/O controller 615 may be or include sensor 650. Sensor 650 may be an example of a digital imaging sensor for taking photos and video. For example, sensor 650 may represent a camera operable to obtain a raw image of a scene, which raw image may be processed by image processing controller 610 according to aspects of the present disclosure.

Transceiver 620 may communicate bi-directionally, via one or more antennas, wired, or wireless links as described above. For example, the transceiver 620 may represent a wireless transceiver and may communicate bi-directionally with another wireless transceiver. The transceiver 620 may also include a modem to modulate the packets and provide the modulated packets to the antennas for transmission, and to demodulate packets received from the antennas. In some cases, the wireless device may include a single antenna 625. However, in some cases the device may have more than one antenna 625, which may be capable of concurrently transmitting or receiving multiple wireless transmissions.

Device 605 may participate in a wireless communications system (e.g., may be an example of a mobile device). A mobile device may also be referred to as a UE, a wireless device, a remote device, a handheld device, or a subscriber device, or some other suitable terminology, where the “device” may also be referred to as a unit, a station, a terminal, or a client. A mobile device may be a personal electronic device such as a cellular phone, a PDA, a tablet computer, a laptop computer, or a personal computer. In some examples, a mobile device may also refer to a WLL station, an IoT device, an IoE device, a MTC device, or the like, which may be implemented in various articles such as appliances, vehicles, meters, or the like.

Memory 630 may comprise one or more computer-readable storage media. Examples of memory 630 include, but are not limited to, a random access memory (RAM), static RAM (SRAM), dynamic RAM (DRAM), a read-only memory (ROM), an electrically erasable programmable read-only memory (EEPROM), a compact disc read-only memory (CD-ROM) or other optical disc storage, magnetic disc storage, or other magnetic storage devices, flash memory, or any other medium that can be used to store desired program code in the form of instructions or data structures and that can be accessed by a computer or a processor. Memory 630 may store program modules and/or instructions that are accessible for execution by image processing controller 610. That is, memory 630 may store computer-readable, computer-executable software 635 including instructions that, when executed, cause the processor to perform various functions described herein. In some cases, the memory 630 may contain, among other things, a basic input/output system (BIOS) which may control basic hardware or software operation such as the interaction with peripheral components or devices. The software 635 may include code to implement aspects of the present disclosure, including code to support deep-learning-based color enhancement systems. Software 635 may be stored in a non-transitory computer-readable medium such as system memory or other memory. In some cases, the software 635 may not be directly executable by the processor but may cause a computer (e.g., when compiled and executed) to perform functions described herein.

Display 640 represents a unit capable of displaying video, images, text or any other type of data for consumption by a viewer. Display 640 may include a liquid-crystal display (LCD), a LED display, an organic LED (OLED), an active-matrix OLED (AMOLED), or the like. In some cases, display 640 and I/O controller 615 may be or represent aspects of a same component (e.g., a touchscreen) of device 605.

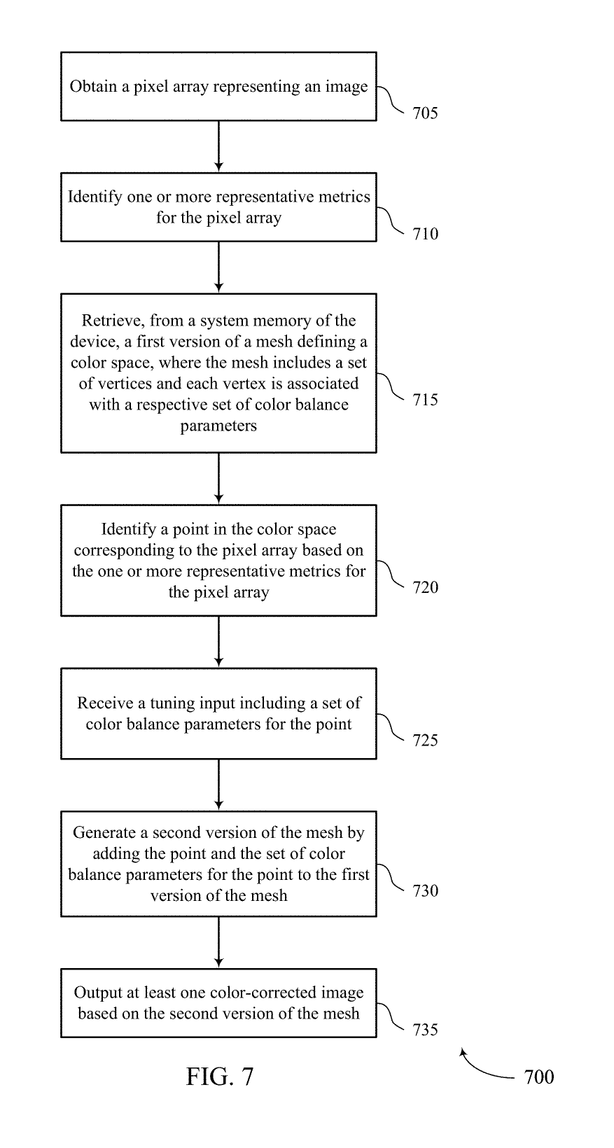

FIG. 7 shows a flowchart illustrating a method 700 for tuning for deep-learning-based color enhancement systems in accordance with aspects of the present disclosure. The operations of method 700 may be implemented by a device or its components as described herein. For example, the operations of method 700 may be performed by an image processing controller as described with reference to FIGS. 5 through 6. In some examples, a device may execute a set of codes to control the functional elements of the device to perform the functions described below. Additionally or alternatively, the device may perform aspects of the functions described below using special-purpose hardware.

At 705 the device may obtain a pixel array representing an image. The operations of 705 may be performed according to the methods described herein. In certain examples, aspects of the operations of 705 may be performed by an array controller as described with reference to FIGS. 5 and 6.

At 710 the device may identify one or more representative metrics for the pixel array. The operations of 710 may be performed according to the methods described herein. In certain examples, aspects of the operations of 710 may be performed by a pixel metrics manager as described with reference to FIGS. 5 and 6.

At 715 the device may retrieve, from a system memory of the device, a first version of a mesh defining a color space, wherein the mesh comprises a set of vertices and each vertex is associated with a respective set of color balance parameters. The operations of 715 may be performed according to the methods described herein. In certain examples, aspects of the operations of 715 may be performed by a mesh fetcher as described with reference to FIGS. 5 and 6.

At 720 the device may identify a point in the color space corresponding to the pixel array based at least in part on the one or more representative metrics for the pixel array. The operations of 720 may be performed according to the methods described herein. In certain examples, aspects of the operations of 720 may be performed by a coordinate manager as described with reference to FIGS. 5 and 6.

At 725 the device may receive a tuning input comprising a set of color balance parameters for the point. The operations of 725 may be performed according to the methods described herein. In certain examples, aspects of the operations of 725 may be performed by an input controller as described with reference to FIGS. 5 and 6.

At 730 the device may generate a second version of the mesh by adding the point and the set of color balance parameters for the point to the first version of the mesh. The operations of 730 may be performed according to the methods described herein. In certain examples, aspects of the operations of 730 may be performed by a mesh update manager as described with reference to FIGS. 5 and 6.

At 735 the device may output at least one color-corrected image based at least in part on the second version of the mesh. The operations of 735 may be performed according to the methods described herein. In certain examples, aspects of the operations of 735 may be performed by a output controller as described with reference to FIGS. 5 and 6.

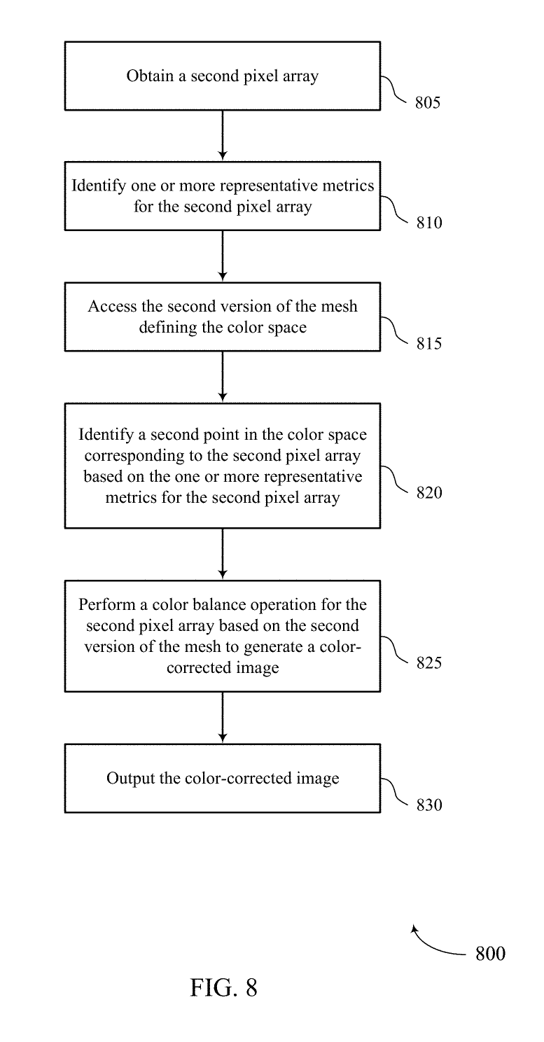

FIG. 8 shows a flowchart illustrating a method 800 for tuning for deep-learning-based color enhancement systems in accordance with aspects of the present disclosure. The operations of method 800 may be implemented by a device or its components as described herein. For example, the operations of method 800 may be performed by an image processing controller as described with reference to FIGS. 5 and 6. In some examples, a device may execute a set of codes to control the functional elements of the device to perform the functions described below. Additionally or alternatively, the device may perform aspects of the functions described below using special-purpose hardware. In some examples, method 800 (e.g., or portions thereof) may be appended to the end of method 700 (e.g. in place of 735).

At 805 the device may obtain a second pixel array representing a second image. The operations of 805 may be performed according to the methods described herein. In certain examples, aspects of the operations of 805 may be performed by an array controller as described with reference to FIGS. 5 and 6.

At 810 the device may identify one or more representative metrics for the second pixel array. The operations of 810 may be performed according to the methods described herein. In certain examples, aspects of the operations of 810 may be performed by a pixel metrics manager as described with reference to FIGS. 5 and 6.

At 815 the device may access the second version of the mesh defining the color space. The operations of 815 may be performed according to the methods described herein. In certain examples, aspects of the operations of 815 may be performed by a mesh fetcher as described with reference to FIGS. 5 and 6.

At 820 the device may identify a second point in the color space corresponding to the second pixel array based at least in part on the one or more representative metrics for the second pixel array. The operations of 820 may be performed according to the methods described herein. In certain examples, aspects of the operations of 820 may be performed by a coordinate manager as described with reference to FIGS. 5 and 6.

At 825 the device may perform a color balance operation for the second pixel array based at least in part on the second version of the mesh to generate a color-corrected image. The operations of 825 may be performed according to the methods described herein. In certain examples, aspects of the operations of 825 may be performed by a color balance manager as described with reference to FIGS. 5 and 6.

At 830 the device may output the color-corrected image. The operations of 830 may be performed according to the methods described herein. In certain examples, aspects of the operations of 830 may be performed by a output controller as described with reference to FIGS. 5 and 6.

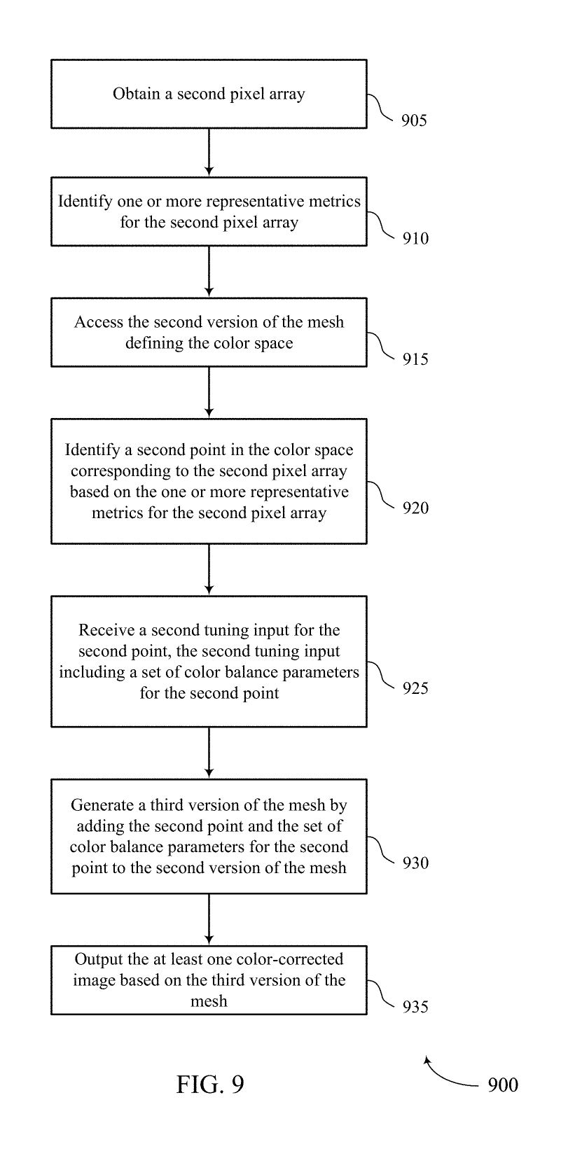

FIG. 9 shows a flowchart illustrating a method 900 for tuning for deep-learning-based color enhancement systems in accordance with aspects of the present disclosure. The operations of method 900 may be implemented by a device or its components as described herein. For example, the operations of method 900 may be performed by an image processing controller as described with reference to FIGS. 5 and 6. In some examples, a device may execute a set of codes to control the functional elements of the device to perform the functions described below. Additionally or alternatively, the device may perform aspects of the functions described below using special-purpose hardware. In some examples, method 900 (e.g., or portions thereof) may be appended to the end of method 700 (e.g. in place of 735).

At 905 the device may obtain a second pixel array representing a second image. The operations of 905 may be performed according to the methods described herein. In certain examples, aspects of the operations of 905 may be performed by an array controller as described with reference to FIGS. 5 and 6.

At 910 the device may identify one or more representative metrics for the second pixel array. The operations of 910 may be performed according to the methods described herein. In certain examples, aspects of the operations of 910 may be performed by a pixel metrics manager as described with reference to FIGS. 5 and 6.

At 915 the device may access the second version of the mesh defining the color space. The operations of 915 may be performed according to the methods described herein. In certain examples, aspects of the operations of 915 may be performed by a mesh fetcher as described with reference to FIGS. 5 and 6.

At 920 the device may identify a second point in the color space corresponding to the second pixel array based at least in part on the one or more representative metrics for the second pixel array. The operations of 920 may be performed according to the methods described herein. In certain examples, aspects of the operations of 920 may be performed by a coordinate manager as described with reference to FIGS. 5 and 6.

At 925 the device may receive a second tuning input for the second point, the second tuning input comprising a set of color balance parameters for the second point. The operations of 925 may be performed according to the methods described herein. In certain examples, aspects of the operations of 925 may be performed by an input controller as described with reference to FIGS. 5 and 6.

At 930 the device may generate a third version of the mesh by adding the second point and the set of color balance parameters for the second point to the second version of the mesh. The operations of 930 may be performed according to the methods described herein. In certain examples, aspects of the operations of 930 may be performed by a mesh update manager as described with reference to FIGS. 5 and 6.

At 935 the device may output the at least one color-corrected image based at least in part on the third version of the mesh. The operations of 935 may be performed according to the methods described herein. In certain examples, aspects of the operations of 935 may be performed by a output controller as described with reference to FIGS. 5 and 6.

It should be noted that the methods described above describe possible implementations, and that the operations and the steps may be rearranged or otherwise modified and that other implementations are possible. Further, aspects from two or more of the methods may be combined. In some cases, one or more operations described above (e.g., with reference to FIGS. 7 through 9) may be omitted or adjusted without deviating from the scope of the present disclosure. Thus the methods described above are included for the sake of illustration and explanation and are not limiting of scope.

The various illustrative blocks and modules described in connection with the disclosure herein may be implemented or performed with a general-purpose processor, a DSP, an ASIC, a FPGA or other programmable logic device (PLD), discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Computer-readable median includes both non-transitory computer storage media and communication median including any medium that facilitates transfer of a computer program from one place to another. A non-transitory storage medium may be any available medium that can be accessed by a general purpose or special purpose computer. By way of example, and not limitation, non-transitory computer-readable media may comprise RAM, ROM, EEPROM, flash memory, CD-ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for color enhancement, comprising:
obtaining a pixel array representing an image;
identifying one or more representative metrics for the pixel array;
retrieving, from a system memory of the device, a first version of a mesh defining a color space, wherein the mesh comprises a plurality of vertices and each vertex is associated with a respective set of color balance parameters;
identifying a point in the color space corresponding to the pixel array based at least in part on the one or more representative metrics for the pixel array;
receiving, from an input controller of the device, a tuning input comprising a set of color balance parameters for the point;
generating a second version of the mesh by adding the point and the set of color balance parameters for the point to the first version of the mesh; and
outputting at least one color-corrected image based at least in part on the second version of the mesh.

2. The method of claim 1, wherein identifying the one or more representative metrics for the pixel array comprises:
generating a first representative metric by applying a first set of convolution operations to the pixel array, the first set of convolution operations using a first set of convolution kernels; and
generating a second representative metric by applying a second set of convolution operations to the pixel array, the second set of convolution operations using a second set of convolution kernels that is different from the first set of convolution kernels.

3. The method of claim 2, wherein identifying the point in the color space for the pixel array comprises:
identifying a horizontal component for the point relative to a coordinate system of the mesh based at least in part on the first representative metric; and
identifying a vertical component for the point relative to the coordinate system of the mesh based at least in part on the second representative metric.

4. The method of claim 1, wherein outputting the at least one color-corrected image based at least in part on the second version of the mesh comprises:
obtaining a second pixel array representing a second image;
identifying one or more representative metrics for the second pixel array;
accessing the second version of the mesh defining the color space; and
identifying a second point in the color space corresponding to the second pixel array based at least in part on the one or more representative metrics for the second pixel array.

5. The method of claim 4, further comprising:
receiving, from the input controller of the device, a second tuning input for the second point, the second tuning input comprising a set of color balance parameters for the second point;
generating a third version of the mesh by adding the second point and the set of color balance parameters for the second point to the second version of the mesh; and
outputting the at least one color-corrected image based at least in part on the third version of the mesh.

6. The method of claim 4, further comprising:
performing a color balance operation for the second pixel array based at least in part on the second version of the mesh to generate a color-corrected image; and
outputting the color-corrected image.

7. The method of claim 6, wherein performing the color balance operation for the second pixel array based at least in part on the second version of the mesh comprises:
identifying a polygon in the second version of the mesh which encompasses the second point, wherein the polygon is defined by a subset of the plurality of vertices and the point; and
determining one or more factors for the color balance operation for the second pixel array based at least in part on the set of color balance parameters associated with the point and the respective set of color balance parameters associated with each of the subset of the plurality of vertices.

8. The method of claim 7, wherein determining the one or more factors for the color balance operation for the second pixel array comprises:
determining a respective Euclidean distance in the color space from the second point to each of the subset of the plurality of vertices and to the point; and
interpolating between the set of color balance parameters associated with the point and the respective set of color balance parameters associated with each of the subset of the plurality of vertices based at least in part on the determined Euclidean distances to determine the one or more factors for the color balance operation.

9. The method of claim 1, wherein receiving the tuning input comprises:
prompting, via a graphical user interface (GUI), a user of the device for the set of color balance parameters for the point.

10. The method of claim 1, wherein obtaining the pixel array representing the image comprises:
capturing the image using an image sensor of the device; or
receiving the pixel array representing the image in a transmission from a second device.

11. An apparatus, comprising:
a processor;
memory in electronic communication with the processor; and
instructions stored in the memory and executable by the processor to cause the apparatus to:
obtain a pixel array representing an image;
identify one or more representative metrics for the pixel array;
retrieve, from a system memory of the apparatus, a first version of a mesh defining a color space, wherein the mesh comprises a plurality of vertices and each vertex is associated with a respective set of color balance parameters;
identify a point in the color space corresponding to the pixel array based at least in part on the one or more representative metrics for the pixel array;
receive, from an input controller of the apparatus, a tuning input comprising a set of color balance parameters for the point;
generate a second version of the mesh by adding the point and the set of color balance parameters for the point to the first version of the mesh; and
output at least one color-corrected image based at least in part on the second version of the mesh.

12. The apparatus of claim 11, wherein the instructions to identify the one or more representative metrics for the pixel array are executable by the processor to cause the apparatus to:
generate a first representative metric by applying a first set of convolution operations to the pixel array, the first set of convolution operations using a first set of convolution kernels; and
generate a second representative metric by applying a second set of convolution operations to the pixel array, the second set of convolution operations using a second set of convolution kernels that is different from the first set of convolution kernels.

13. The apparatus of claim 11, wherein the instructions to output the at least one color-corrected image based at least in part on the second version of the mesh are executable by the processor to cause the apparatus to:
obtain a second pixel array representing a second image;
identify one or more representative metrics for the second pixel array;
access the second version of the mesh defining the color space; and
identify a second point in the color space corresponding to the second pixel array based at least in part on the one or more representative metrics for the second pixel array.

14. The apparatus of claim 13, wherein the instructions are further executable by the processor to cause the apparatus to:
receive, from the input controller of the apparatus, a second tuning input for the second point, the second tuning input comprising a set of color balance parameters for the second point;
generate a third version of the mesh by adding the second point and the set of color balance parameters for the second point to the second version of the mesh; and
output the at least one color-corrected image based at least in part on the third version of the mesh.

15. The apparatus of claim 13, wherein the instructions are further executable by the processor to cause the apparatus to:
perform a color balance operation for the second pixel array based at least in part on the second version of the mesh to generate a color-corrected image; and
output the color-corrected image.

16. The apparatus of claim 15, wherein the instructions to perform the color balance operation for the second pixel array based at least in part on the second version of the mesh are executable by the processor to cause the apparatus to:
identify a polygon in the second version of the mesh which encompasses the second point, wherein the polygon is defined by a subset of the plurality of vertices and the point; and
determine one or more factors for the color balance operation for the second pixel array based at least in part on the set of color balance parameters associated with the point and the respective set of color balance parameters associated with each of the subset of the plurality of vertices.

17. The apparatus of claim 16, wherein the instructions to determine the one or more factors for the color balance operation for the second pixel array are executable by the processor to cause the apparatus to:
determine a respective Euclidean distance in the color space from the second point to each of the subset of the plurality of vertices and to the point; and
interpolate between the set of color balance parameters associated with the point and the respective set of color balance parameters associated with each of the subset of the plurality of vertices based at least in part on the determined Euclidean distances to determine the one or more factors for the color balance operation.

18. A non-transitory computer-readable medium storing code for color enhancement, the code comprising instructions executable by a processor to:
obtain a pixel array representing an image;
identify one or more representative metrics for the pixel array;
retrieve a first version of a mesh defining a color space, wherein the mesh comprises a plurality of vertices and each vertex is associated with a respective set of color balance parameters;
identify a point in the color space corresponding to the pixel array based at least in part on the one or more representative metrics for the pixel array;
receive a tuning input comprising a set of color balance parameters for the point;
generate a second version of the mesh by adding the point and the set of color balance parameters for the point to the first version of the mesh; and
output at least one color-corrected image based at least in part on the second version of the mesh.

19. The non-transitory computer-readable medium of claim 18, wherein the instructions to identify the one or more representative metrics for the pixel array are executable by the processor to:
generate a first representative metric by applying a first set of convolution operations to the pixel array, the first set of convolution operations using a first set of convolution kernels; and
generate a second representative metric by applying a second set of convolution operations to the pixel array, the second set of convolution operations using a second set of convolution kernels that is different from the first set of convolution kernels.

20. The non-transitory computer-readable medium of claim 18, wherein the instructions to output the at least one color-corrected image based at least in part on the second version of the mesh are executable by the processor to:
obtain a second pixel array representing a second image;
identify one or more representative metrics for the second pixel array;
access the second version of the mesh defining the color space; and
identify a second point in the color space corresponding to the second pixel array based at least in part on the one or more representative metrics for the second pixel array.
